(19) United States
(12) Patent Application Publication
(10) Pub. No.: US 2024/0065446 A1
(43) Pub. Date: Feb. 29, 2024

(54) Modular Sofa System

(71) Applicants: Benjamin Parsa, El Dorado Hills, CA (US); Antonin Agdigos, Sacramento, CA (US)

(72) Inventors: Benjamin Parsa, El Dorado Hills, CA (US); Antonin Agdigos, Sacramento, CA (US)

(21) Appl. No.: 17/893,216

(22) Filed: Aug. 23, 2022

(51) Int. Cl. A47C 13/00; A47C 7/18; F16B 12/12

(52) U.S. Cl. CPC A47C 13/005; A47C 7/18; F16B 12/12

(57) ABSTRACT

A modular sofa system, where each module includes a generally square frame and one or more arm or back elements; and where the feet of the arm or back elements are constructed to support the generally square frame. The separate modules can be joined together to form a sofa of the desired configuration.

### TECHNICAL FIELD

The invention relates to the field modular furniture, and particularly to a modular sofa system.

### BACKGROUND OF THE INVENTION

Sofas, also referred to as couches or settees, are a common and popular form of furniture for households and other environments. Most sofas include one or more horizontal seating sections characterized by one or more seat cushions in addition to relatively rigid back and arm sections, generally cushioned, to enable comfortable seating, lounging, or horizontal resting. A common sofa design can be found in U.S. design Pat. No. D514347.

Sofas often come in the form of a single straight seating section, where a rigid frame comprising the body of the unit typically rests on legs, has an integrated cushioned seating surface, an integrated upholstered back, and one or more rigid arm or end sections.

While traditional sofas are sold as a single piece, modular sofas are also known. For example, U.S. Pat. No. 321,825, issued in 1885, is directed to a modular sofa bed and chair. Modular sofas are characterized by similar modules that can be combined in various ways to form a larger sofa unit. At a minimum, modular sofas can be comprised of a single module, in the form of a chair or ottoman. More commonly, a modular sofa is formed by combining or arranging two or more modules into a standard rectangular sofa, or even an “L” or “U” configuration, resulting in a so-called “sectional” sofa. Such configurations allow for additional seating capacity within the same sofa unit. U.S. Pat. No. 10,433,648 teaches an elaborate modular sofa system, where modules are fabricated with interfaces and connectors and can be joined together to form larger units.

In recent years, particularly during the COVID-19 pandemic, there has been increased demand for furniture that can be purchased online and shipped to customers. Online shopping and the direct shipment of furniture, particularly unassembled furniture, can offer significant benefits for both customers and manufacturers. For customers, online furniture shopping offers convenience, removing the need to personally transport and carry often heavy and unwieldy furniture, customization in terms of fabric and color selection and overall configuration, as well as typically lower cost.

For manufacturers, online direct-to-customer sale and shipment of furniture can significantly lower costs that arise from, for example, the need to maintain or collaborate with retail establishments, to store assembled but unsold units, and to arrange for delivery of pre-assembled furniture. Furniture, particularly sofas, is often large, heavy, unwieldly, and inconvenient to transport and deliver. Shippers like UPS™, for example, limit the weight of shipped items to 150 lbs and dimensions to 165 inches in length and girth combined, which is insufficient for most sofas.

Additionally, sofas are often subject to significant use and abuse and must be stable and durable enough to serve their intended purpose while also being comfortable and having aesthetic appeal. This remains the case even though some customers may not be adept at assembling components or modules suitable for shipment via common economical means into sofas that meet expectations regarding comfort, resilience, and appeal.

There is therefore a need for a sofa system conducive to online ordering and direct-to-customer shipment and assembly that also satisfies customer expectations regarding durability, resilience, comfort, aesthetic appeal, ease of assembly, and overall function.

### SUMMARY

The modular sofa system described herein meets the challenge of allowing for online ordering, economical shipment, and ease of assembly, while also providing the advantages characteristic of a traditional sofa, such as durability and aesthetic appeal.

The embodiments described herein permit an upholstered sofa to be manufactured, packaged, shipped, and assembled in a manner that maintains the quality of the sofa while allowing for the transport, assembly, and combination of sofa components or modules in a convenient and economical manner. While the embodiments discussed herein are well-suited to online shopping and ordering, they can also be ordered from a showroom or other environment.

Embodiments of the present invention allow for the efficient manufacture, shipping, and assembly of a variety of sofa configurations through the use of modular design and packaging, where each package contains the components of a single sofa module, and where the design of each module permits combination with other modules to form a sofa in a variety of arrangements. For example, four-module units can be efficiently packed and shipped in four separate packages, which can be combined to form a single sofa with the desirable features of a traditional sofa.

During the invention process, it was determined that it would not be unproblematic to create a modular sofa systems that could be manufactured, packaged, shipped, and assembled by an end-user in an efficient manner and also exhibited the desirable features of a traditional sofa. In particular, the inventors determined that the stresses placed on the load-bearing components of a module, such as the arms and back, would not provide adequate stability and durability for extended use without damage. Even if the base of the sofa were placed on the floor, which itself has undesirable drawbacks in terms of appeal and soiling, it was difficult to connect the arms and back to the base of a module via a single point of attachment without the elements being subjected to excessive stresses. The difficulty was compounded by the need to use components amenable to efficient packing and assembly.

Seeking to discover an acceptable design for the load-bearing connection points of the arm and back of a sofa module, particularly in light of the need for a soft and durable seat cushion resting on a horizontal frame, the inventors experimented with attaching metal back and arm elements to a metal base via screws or bolts driven through horizontal flanges extending inward from the arm and back to the three corners of the base. This seeming sturdy, if unwieldly, design afforded inadequate stability given the significant distance between the base and the top of the arm or back, the vertical portions of which operated as levers conveying undue stress to the point of connection to the base.

It was also determined that having the back and arm elements independent of the frame would generally not be stable. While a generally square frame could potentially be quite deep to permit many points of connection between the arm and back elements and the frame, such a design would not be conducive to placement of a comfortable cushion on the frame or ease of packing, shipment, and assembly.

Over the course of experimentation, however, the inventors conceived and fabricated a design suitable for reconciling the range of competing constraints involved in developing a modular sofa system that offers the advantages of a traditional sofa. It was determined that the generally square frame of a module could be placed on top of a lip or ledge formed into the interior facing ends of the foot portion of the back and arm sections, distributing the downward force from weight on the seating area to the back and arm elements, thereby imparting additional stability and durability to the module.

Various features are characteristic of the solution arrived at by the inventors, though different elements can be modified within the framework of the general invention to achieve similar results. In a preferred embodiment, the back and arm elements are of similar or identical design, with each arm or back element comprised of four different rectangular wood pieces of substantially greater length than width or depth. In an assembled sofa module, each arm or back element of the embodiment is comprised of two horizontal beams connected to two vertical posts, with the bottom of the lower horizontal beam about halfway down the posts. At the bottom of the posts are formed two feet configured for placement under the bottom of the substantially square frame of the module, such that downward force on the frame is distributed in manner that imparts additional stability to the arm or back elements containing the foot on which the frame rests.

In a preferred embodiment, the upper half of the interior of the back or arm beams are angled away from the interior at around 20 degrees from vertical, which is favorable for the placement and retention of arm or back cushions resting against the back and arm elements. Additionally, the bottom of the lower horizontal beam of the arm or back element is situated so that it is below the top of the primary seating cushion, such that the back or arm cushions do not fall out of the side or back of the sofa.

In a preferred embodiment, each unassembled module is comprised of a significantly square hollow structure formed by four wood pieces that serves as a frame for the module, to which an arm piece, back piece, or both are attached during assembly, and where the lower portion of the arms and back contain a ledge or foot extending below the frame. For example, a straight sofa comprised of three modules comes in three boxes, two for the end modules that each include a frame, an arm piece, and a back piece, and one package for the middle module that includes a frame and back piece. The end modules would also each include a leg assembly for separate attachment to the frame (or, optionally, pre-attached or integrated into the frame) at the corner opposite the intersection of the arm and back pieces, while the package for the middle module would contain a back piece and two leg assemblies for separate attachment to the frame (or, optionally, pre-attached or integrated into the frame) at each front corner of the middle module.

To permit more efficient shipping and assembly, the arm piece(s), back piece(s), and leg piece(s) of the sofa can be packed in a generally flat manner within the generally square hollow frame of the module, with the height of the package corresponding roughly to the width of the fame. In this manner, the overall dimensions of the package can be reduced, excess packaging material eliminated, and disturbance of the components during shipment minimized, resulting in easier and more efficient shipment and handling. Thus, the design not only offers the stability and durability characteristic of a traditional sofa via a modular sofa system, the modules are designed in a manner conducive to simplified packing, shipping, and assembly.

The cushioned seat of a sofa is a significant component for comfort, stability, and aesthetic appeal. Some sofas have seat cushions integrated into the frame and others offer removeable seat cushions that rest on the frame, as is common with sofa beds. In an embodiment of the present invention, the inventors have found it advantageous to use relatively thick multi-layer memory foam (viscoelastic polyurethane foam or low-resistance polyurethane foam) assembly of approximately 12 inches as the seat cushion, which provides comfort, stability, and aesthetic appeal. In one embodiment, the multi-layer seat cushion is formed from a rectangular solid of relatively dense foam approximately 8 inches thick upon which two additional layers of softer foam, each approximately 1.5 inches thick, rest. A sheet of soft material, such as Dacron™, forms the top layer. The seat is then wrapped in an air mesh cover to secure the layers into a completed seat cushion assembly. As the seat cushion assembly is made primarily of foam components, air can be evacuated from the cushion assembly to reduce its size and permit more efficient shipping.

To ensure the seat cushion is stable and secure on the modular assembly, in one embodiment the seat cushion can be permanently or removably housed within the desired sofa fabric, as with a sewn or a zippered pouch, where the bottom of the seat cushion fabric or housing that is in connection with the seat frame is made from or treated with rubber or other high-friction material, such that the bottom of the seat cushion does not slide away from the frame due to horizontal forces generated by the sofa user. That is, while five of the sides of cushion are covered in the desired fabric, the bottom of the fabric-enclosed cushion is treated with or composed of high-friction material.

In an embodiment, a series of relatively firm flat bands are attached to the upper portion of the generally square modular frame in an interleaved or woven manner. In one embodiment, five flat bands approximately 2 inches in width are stapled about 3.5 inches apart across opposite sides of the frame and interleaved together. In the assembled module, the bottom of the seat cushion rests on the interleaved bands attached to the frame, which provide a suitably pliant but high-friction base for the cushion.

As each module is designed to have independent stability, the modules can be connected and combined using a range of techniques to form a completed sofa. For example, the frame of each module can be bolted to its neighbor(s) during assembly, or neighboring frames can be grooved to permit connection using standard forms of joinery, such as dovetails. In a preferred embodiment, one or more metal clamps are provided for the user to clamp neighboring frames to one another during assembly to generate the desired modular arrangement for the completed sofa.

### BRIEF DESCRIPTION OF THE DRAWINGS

A more complete and thorough understanding of the present embodiments and advantages thereof may be acquired by referring to the following description taken in conjunction with the accompanying drawings, wherein:

FIG. 1 is a front view of a straight sofa comprised of three modules.

FIG. 2 is a front elevated view of an “L” sectional sofa comprised of four modules.

FIG. 3 is a side view of an arm or back element connected to a module frame.

FIG. 4 is a close-up view indicating how the legs of an arm or back element can be connected to a module frame.

FIG. 5 is an elevated rear view showing how legs not connected to an arm or back element can be connected to a module frame.

FIG. 6 is a close-up view indicating how legs not connected to an arm or back element can be connected to a module frame.

FIG. 7 is an elevated view of interleaved bands connected to a module frame.

FIG. 8 is a blowout view depicting how an arm, back, and separate leg can be packaged for shipment within the frame of a module.

### DETAILED DESCRIPTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

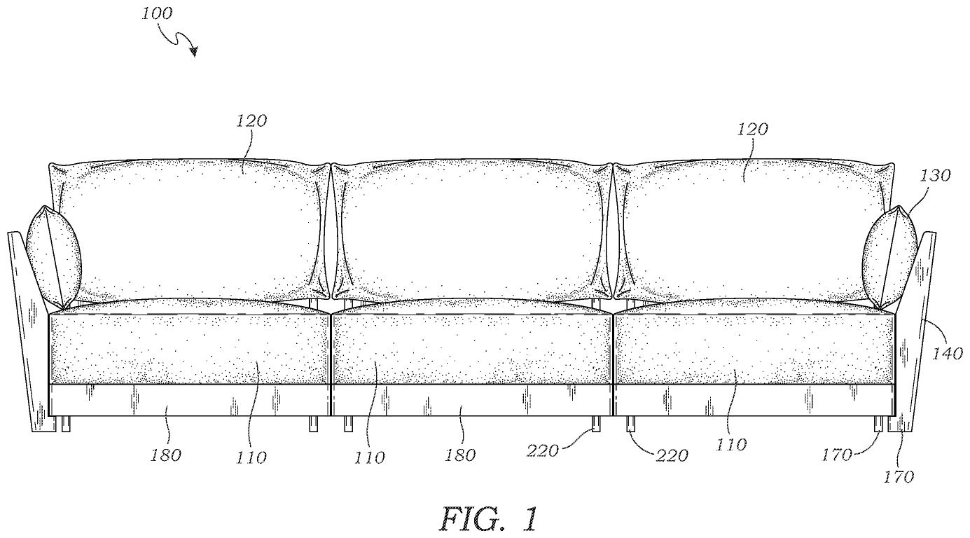

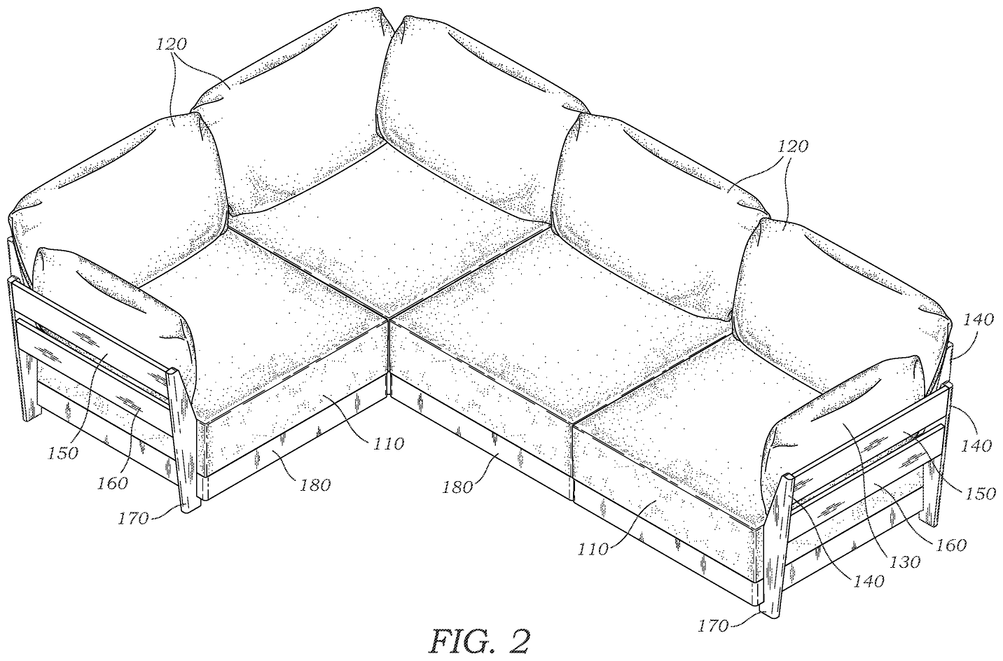

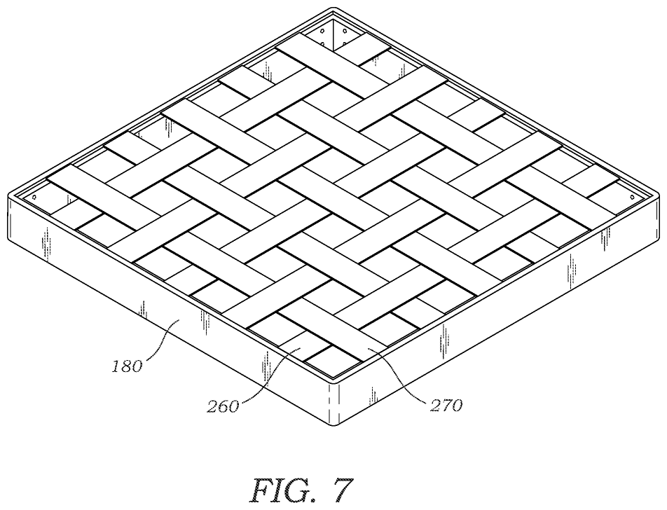

Modular sofas according to an embodiment of the invention are illustrated in FIGS. 1-2. FIG. 1 a front view of a straight sofa 100 comprised of three modules. FIG. 2 illustrates a front elevated view of an “L” sectional sofa comprised of four modules. Each module is built around a hollow generally square frame 180. The seat cushion for each module 110 rests on the top of the generally square frame 180 to which interleaved bands of elastic material are attached, as depicted in FIG. 7.

As appropriate for a given modular configuration, arm and back elements 140 are also attached to the frame 180. For example, the middle module in FIG. 1 would only have one back element and no arm elements attached, as the two sides are connected to other modules to form a completed sofa. Alternatively, a single module in the form of a chair would have one back element and one arm element on each side to form the intended product. A module intended for use as an ottoman would have no attached back or arm elements but would otherwise be similar to other modules. The bottom portion of each back and arm element 140 is configured in the form of a foot 170, where the frame rests on the top of the foot, imparting stability to the unit.

For portions of the frame that do not otherwise rest on the foot 170 of a back or arm element 140, such as the front corners of the middle module in FIG. 1, a separate foot assembly 200 is provided for attachment to the frame. Alternatively, the frame can be manufactured such the additional foot is carved into or prefabricated as part of the frame.

FIG. 2 depicts additional details of the back and arm elements 140 according to an embodiment of the present invention. In this embodiment, the back and arm elements 140 are of the same design and are interchangeable, which further promotes ease of manufacture, shipping, and assembly. Each back or arm element 140 has two vertical legs on opposite ends that are connected to two flat horizontal beams 150 and 160 of substantially greater length than width or depth. The upper horizontal beam 150 is joined to each vertical leg 140 at or near the top of the leg. The lower horizontal beam 160 is joined to each vertical leg 140, such that the bottom of the lower horizontal beam 160 is below the top of the seat cushion 110 in an assembled module. This prevents the back cushions 120 and arm cushions 130 from sliding out the back or the side of the sofa during normal use.

However, a variety of different embodiments of the back and arm elements are contemplated. For example, the back and arm elements do not need to be of the same design, and they do not need to contain two horizontal beams. There could be a single generally square piece that connects the two legs from top to bottom, or there could be a number of horizontal beams attached along the length of the back or arm element.

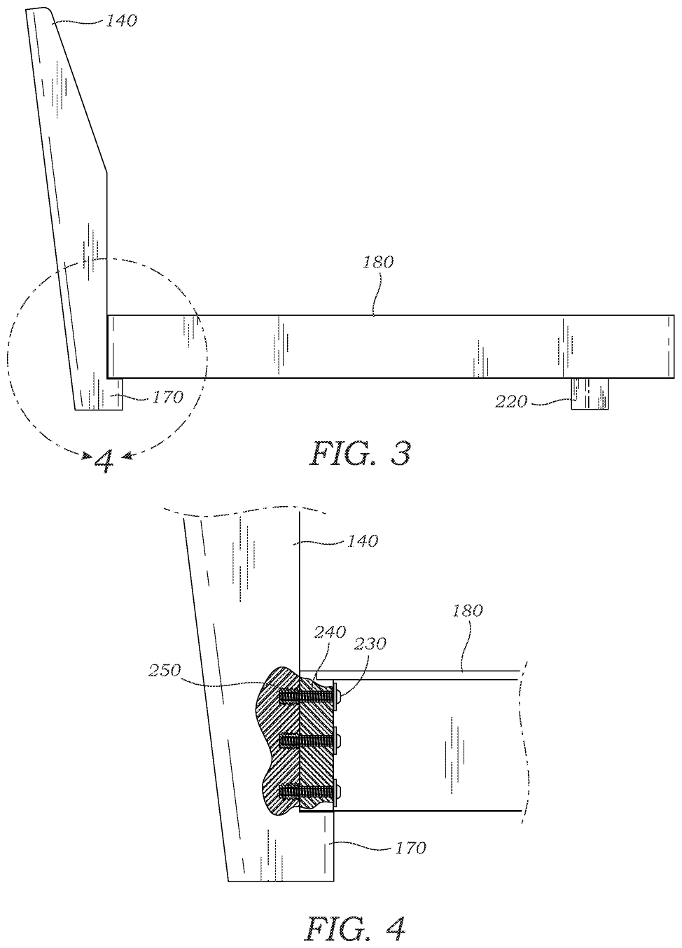

FIG. 3 illustrates a side view of an arm or back leg 140 connected to a module frame 180. A close-up of the points of connection is depicted in FIG. 4. The frame 180 rests on the foot 170 of the leg 140 of an arm or back element. However, the frame 180 must also be fastened or joined to the leg 140 so that downward force from the frame 180 to the foot 170 of the leg 140 is imparted to the back or arm element in a manner that provides stability and durability to the module and resulting sofa.

In the depicted embodiment, each end of the frame 180 that will be connected to a leg of a back or arm element is pre-drilled with three holes 240 in a vertical configuration for connection to the leg 140 via three bolts 230. Each leg is fitted with three threaded inserts or rivet nuts 250 in a vertical configuration that correspond to the three holes 240 in a vertical configuration pre-drilled into the frame. Three bolts can then be threaded through the holes in the frame into the threaded inserts or rivet nuts 250. In this manner, the frame is joined to the back and arm elements, such that the force imparted from the frame to the foot 170 of the legs 140 of the arm or back elements helps to stabilize and secure the back or arm elements and the module as a whole. While the inventors have determined the above configuration successfully imparts stability to the unit and promotes ease of manufacture and assembly, other methods of fixedly joining the frame to the legs of the back or arm elements would also be apparent to those having skill in the relevant art.

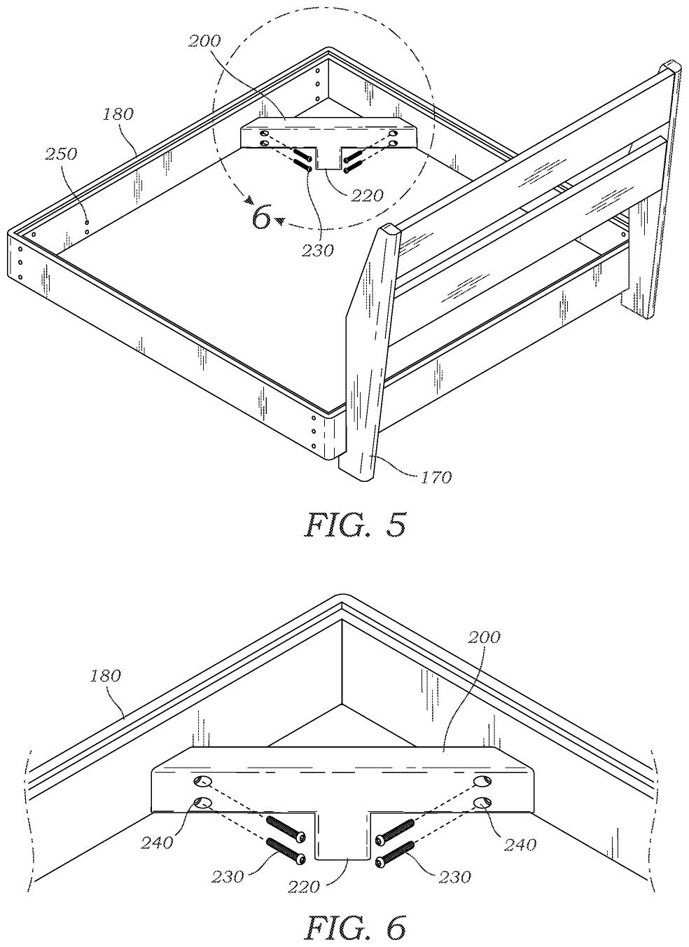

FIG. 5 illustrates an elevated rear view depicting how legs 200 not connected to an arm or back element can be connected to a module frame 180. In this embodiment, the frame includes pre-drilled holes 250 for attachment of the leg assembly 200.

FIG. 6 is a close-up view indicating how legs not connected to an arm or back element 200 can be connected to a module frame. In this embodiment, the leg assembly 200 contains holes 240 through which bolts 230 can be tightened into the frame 180. Optionally, the frame 180 can contain threaded inserts or rivet nuts into which the bolts are seated. Because modules that have more than one leg not connected to an arm or back element are typically connected to two other modules (or serve as ottomans), the overall stability of the modular sofa is not significantly affected by one or two legs not attached to an arm or back element. While the inventors have found that the arrangement of independent legs as depicted in FIGS. 5 and 6 is well-adapted to a modular sofa system, a variety of other approaches to fastening or attaching legs not associated with arm or back elements, such as prefabricated legs fixedly attached the frame 180 during manufacture, would be apparent to those having skill in the relevant art.

FIG. 7 is an elevated view that depicts interleaved slats or bands connected to a module frame 180 on which the seat cushion of the module rests. In a preferred embodiment the bands 260 and 270 are made from a relatively firm woven material such as Nylon™. In this embodiment, five bands of approximately 2 inches in width an around 0.1 inch in thickness are stapled about 3.5 inches apart across opposite sides of the frame and are interleaved or woven with the perpendicular bands. In this manner, a strong but suitably pliant surface for the seat cushion is formed. Preferably, the bands provide some friction to the bottom of the seat cushion assembly, the bottom of which may be formed from or treated with a high-friction material such as rubber. In this way, the seat cushion of the module is held firm and not subject to dislocation by the common lateral forces applied to seat cushions.

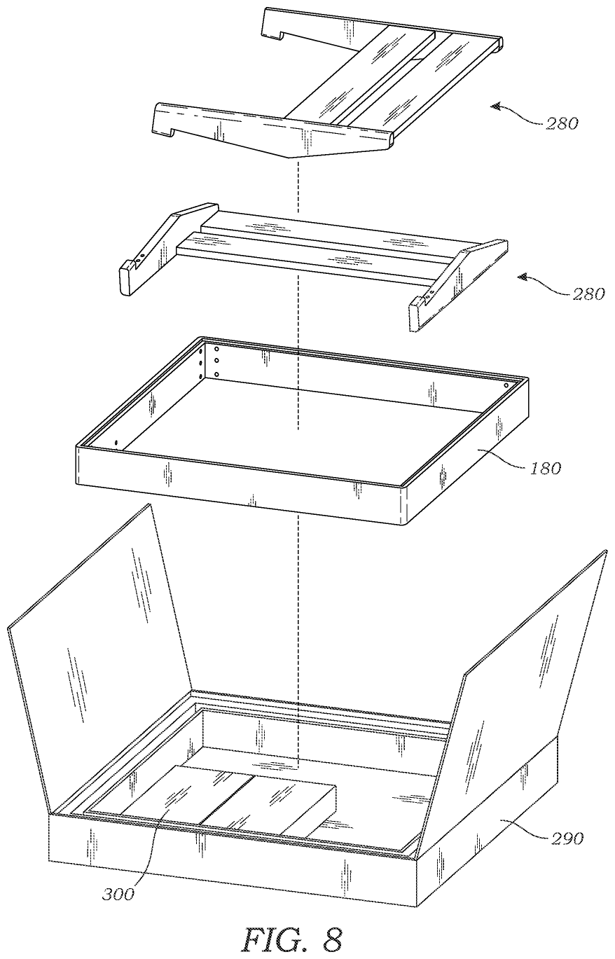

FIG. 8 is a blowout view depicting how a frame 180, arm element 280, back element 280, and separate leg 300 can be conveniently and efficiently packed in a package 290 for shipment. In this embodiment, the frame 180 is placed within a package made of standard material, such as cardboard, whose dimensions are somewhat larger than the frame. In this manner, the hollow frame reinforces the strength of the package 290 and defines a space in which other elements of the module can be packed.

As depicted in FIG. 8, the arm and back elements 280 can be laid on top of one another, efficiently using packing space and also reinforcing the top and bottom of the package 290 after it is sealed. A separate package 300 or packages for the one or more leg assemblies 200 can also be placed into unoccupied voids of the package 290, in addition to assembly tools, hardware, fasteners, module clamps, instructions, and/or other items. If the bands 260 and 270 have been pre-installed by the manufacturer, the frame 180 can be placed upside down, with the other elements being set on top of the bands 260 and 270, which rest on the bottom of the package. In this manner, individual modules for the desired sofa configuration can be conveniently packaged and efficiently shipped.

Modifications and substitution by one of ordinary skill in the art are considered to be within the scope of the present invention, which is not limited except by the following claims.

What is claimed is:

1. A modular sofa system, where each module includes a generally square frame and one or more arm or back elements; and
where the feet of the arm or back elements are constructed to support the generally square frame.

2. The modular sofa system of claim 1, where the arm and back elements of each module are substantially similar and interchangeable.

3. The modular sofa system of claim 1, where the arm and back elements are each comprised of two vertical legs with feet upon which the generally square frame rests, and where each vertical leg of the arm or back element is connected to the other vertical leg via one or more horizontal beams.

4. The modular sofa system of claim 3, where each leg of the arm and back elements for each module is attached to the generally square frame by three bolts.

5. The modular sofa system of claim 4, where each bolt is seated into a leg through threaded inserts or rivet nuts in the leg that accommodate the bolt.

6. The modular sofa system of claim 3, where each vertical leg of a back or arm element is connected to the other vertical leg via two or more horizontal beams.

7. The modular sofa system of claim 6, where the bottom of the lowest horizontal beam is below the top of the seat cushion.

8. The modular sofa system of claim 1, where each module of the sofa is joined to other modules via a removable frame clamp.

9. The modular sofa system of claim 8, where the removeable frame clamp is positioned between the interwoven bands that form the tops of adjacent module frames.

10. The modular sofa system of claim 1, where the corners of the generally square frame not supported by the feet of an arm or back element are supported by a leg assembly attached to the frame.

11. The modular sofa system of claim 1, where interwoven bands are affixed to the top of the generally square frame, and where the bottom of the seat cushion rests on the interwoven bands.

12. The modular sofa system of claim 11, where the interwoven bands are stapled to the top of the frame.

13. The modular sofa system of claim 1, where the seat cushion for a module is formed from one or more layers of memory foam.

14. The modular sofa system of claim 13, where the seat cushion is formed from two or more layers of memory foam, and where the bottom layer of memory foam is at least as thick as all other layers of memory foam combined.

15. The modular sofa system of claim 13, where the seat cushion is enclosed in fabric, and where bottom of the fabric is treated with rubber or other high-friction material.

16. The modular sofa system of claim 1, where each module is designed for convenient shipping, such that the shipping package substantially conforms to the dimensions of the generally square module frame, and the structural elements of the module and associated parts are packed into a single shipping package.
